(19) United States
(12) Patent Application Publication
(10) Pub. No.: US 2007/0220797 A1
(43) Pub. Date: Sep. 27, 2007

(54) Tray identification end piece

(76) Inventors: Keith E. Antal, Valatie, NY (US); Chad E. Lagace, Cohoes, NY (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/728,803

(22) Filed: Mar. 26, 2007

Related U.S. Application Data
(60) Provisional application No. 60/786,230, filed on Mar. 27, 2006.

(51) Int. Cl. G09F 3/20; B25G 3/32

(52) U.S. Cl. 40/658; 16/422

(57) ABSTRACT

An end piece is provided and removably secured to an edge of a tray to facilitate identification of the contents of the tray. The color of the end piece may be selected to correspond to the contents of the tray.

### CROSS-REFERENCE TO RELATED APPLICATION

This application claims the benefit of U.S. provisional patent application Ser. No. 60/786,230, filed on Mar. 27, 2006 and entitled “Tray Identification Clip.”

### TECHNICAL FIELD

The present invention relates to an end piece that may be clipped to a tray for food processing or the like to identify the contents of the tray.

### BACKGROUND INFORMATION

Restaurants typically use multiple trays at any given time to prepare food. With multiple trays in a given location, for example, in an oven, it becomes important to know which tray contains which food item.

Restaurants presently use different color trays to distinguish between the various contents of the tray. However, using different colored trays requires having a greater number of trays than using a single color tray for all purposes, resulting in additional expense and the need for additional storage space.

### SUMMARY

An end piece is provided that may be secured to a tray during storage or food processing. The end piece includes a top and bottom, connected by a side wall. The form of the end piece is created to mechanically adhere to the lip of a tray. Another example of the end piece includes a face having a generally J-shaped wing extending from each end. The wings are structured to wrap at least partially around a handle or lip of a tray. The end piece may be provided in different colors, with different colors corresponding to different tray contents. The end piece may thereby identify the contents of a tray when the tray is in use, such as wherein the edge of the tray and the attached end piece are visible in the open end of an oven, but the contents of the tray are not visible.

A method of identifying trays used for different contents is also provided. The method includes providing an end piece having a color selected to correspond to the contents of the tray, securing the end piece to the edge of the tray and placing the tray in a storage or processing location with the end piece visible.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is an isometric front side view of an embodiment of an end piece for a tray as contemplated by the present invention.

FIG. 2 is an isometric rear side view of the end piece of FIG. 1.

FIG. 3 is an isometric view of the end piece of FIG. 1, shown secured to the end of a tray.

FIG. 4 is an isometric view of a pair of trays with the end pieces of FIG. 1 secured to the trays and with the trays stacked on top of one another.

FIG. 5 is an isometric view of another embodiment of an end piece, shown secured to the end portion of a tray.

FIG. 6 is a perspective view of a further embodiment of an end piece, shown secured to the end of an alternate tray construction.

FIG. 7 is a top plan view of the end piece embodiment of FIG. 6.

FIG. 8 is a bottom plan view of the end piece embodiment of FIG. 6.

FIG. 9 is an end view of a tray and the end piece embodiment of FIG. 6, shown positioned in an oven.

### DETAILED DESCRIPTION

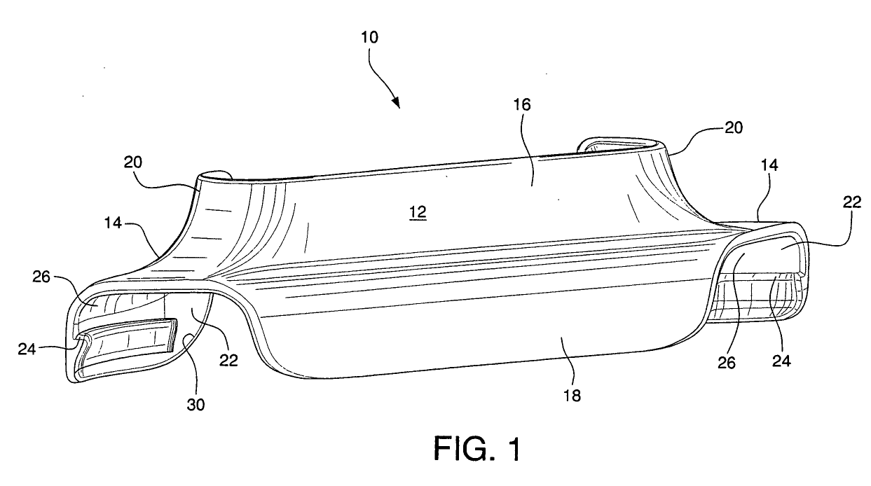

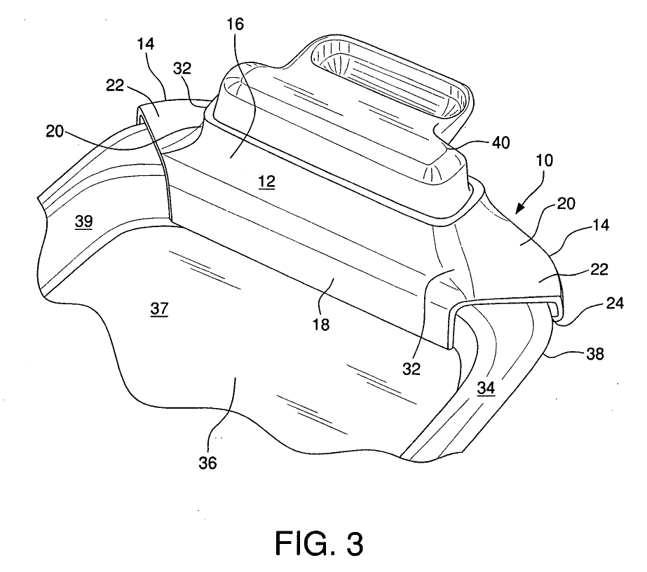

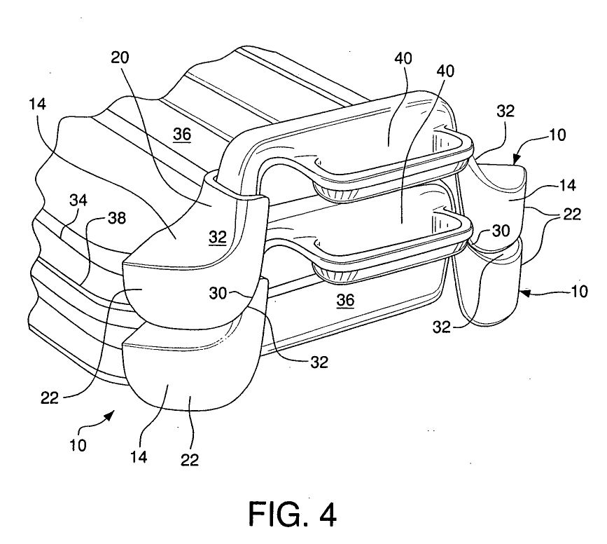

In the drawings, where like numerals identify like elements, there is shown a number of embodiments of an end piece which may be attached to a tray for use in storage, food processing or the like. In FIGS. 1-4, the end piece is generally designated by the reference numeral 10. The end piece 10 may be secured to a tray 36 to facilitate identification of the contents of the tray (see, e.g., FIGS. 3 and 4).

For the purpose of this description, a tray is defined as any article that is used to contain and/or support articles, such as food, during storage or processing. In the examples provided, the trays are generally flat with a raised side edge. The end piece is a device that may be removably secured to the end or handle on a tray. An end piece is preferably removably secured to a tray, but will not separate from the tray without some minimal applied force.

Referring to FIGS. 1-4, the end piece 10 includes a face 12 having a pair of wings 14 secured to opposing ends of the face 12. The face 12 includes a top portion 16 structured to abut a handle 40 of the tray 36 (see FIG. 3). The inside surface 28 of a lower portion 18 of the face 12 is structured to abut one side of an edge of a tray. Each of the wings 14 includes a top portion 20, which is structured to wrap around the handle 40 of the tray 36. The top portions 20 of the wings 14 are connected to the top portion 16 of the face 12. A lower portion 22 of each wing 14 is structured to abut an opposing side edge of a tray, so that the edge of the tray is secured between the lower portion 18 of the face 12 and the lower portion 22 of the wings 14. As illustrated, the end piece 10 is structured to accommodate a tray having a handle 40. Alternative examples of the end piece may simply fit over the edge of a tray without an extended handle.

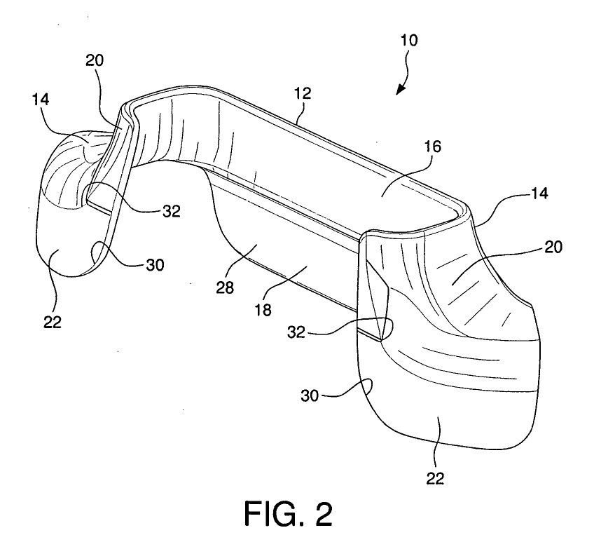

A J-shaped hook 24 extends from the interior surfaces 26 of the lower portion 22 of the wings 14 (FIG. 1) and/or from the inner surface 28 of the lower portion 18 of the face 12 (FIG. 2; hook not shown). As illustrated, the hook 24 projects inward from the lower portions 22 of each wing 14. The hook 24 is structured to engage the lip 38 of rim 34 (FIG. 3).

The end piece 10 includes a lower edge surface 30 defined along the bottom of each wing 14. The dimensions and configuration of the lower edge 30 are structured to nest with the upper surfaces 32 of the wings 14 of another end piece 10, so that the nesting adjacent end pieces may properly support a plurality of trays that have been stacked (FIG. 4).

Referring specifically to FIG. 3, the end piece 10 is shown in use with a tray 36. The tray 36 includes a bottom surface 37 surrounded by a side wall 39. A handle 40 extends upward from the side wall 39. An edge or rim 34 is defined along the top of the side wall 39. The end piece 10 is removably secured to the edge 34. The hook 24 engages the under side of the rim 34 or a defined lip 38 on the underside of the rim 34. The handle 40 extends upward between the top portion 16 of the face 12 and the top portion 20 of the wings 14.

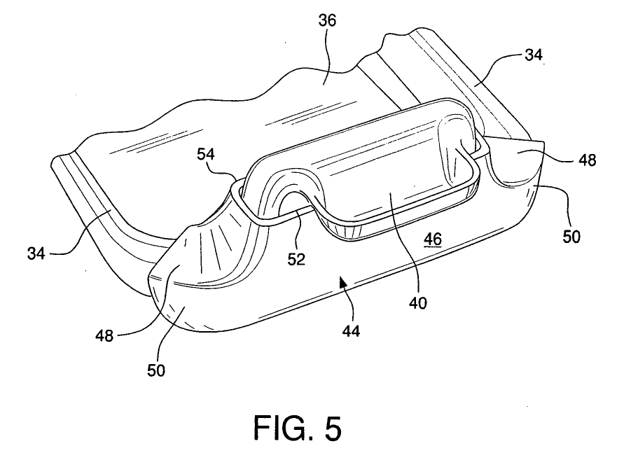

FIG. 5 shows an alternative end piece 44 secured to the tray 36. The end piece 44 is similar to the end piece 10, while also including a continuous rear face 46 secured to the wings 50. An opening 52 is defined in the top of the end piece 44, between the front face 54, the top surfaces 48 of the wings 50 and the rear face 46. The opening 52 defines a space for receiving the handle 40 of the tray 36. The end piece 44 is secured to the tray 36 in the same manner as the end piece 10, preferably by a friction fit around the rim 34 and handle 40.

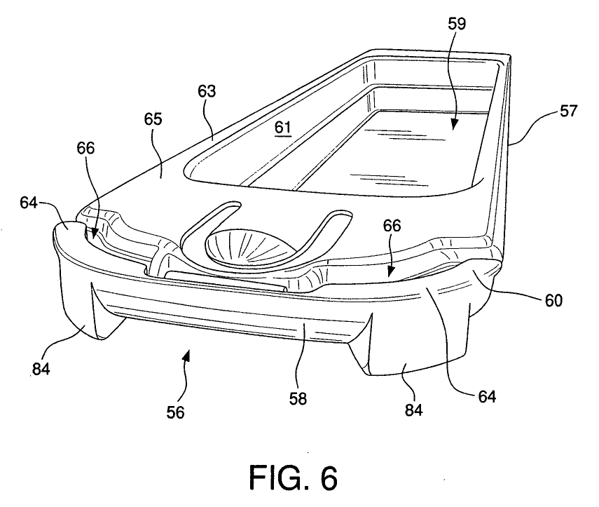

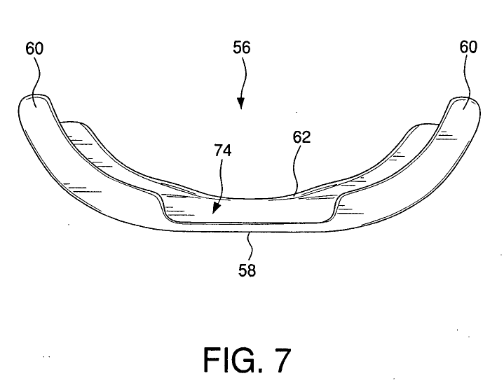

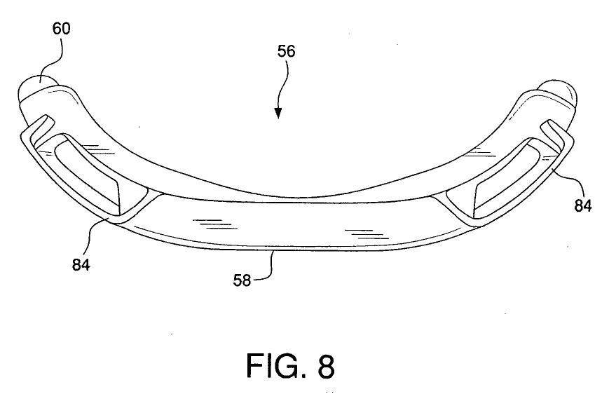

Referring to FIGS. 6-9, another embodiment of an end piece 56 is illustrated. The end piece 56 is contemplated for use with a tray having, for example, the structure disclosed in commonly assigned U.S. patent application Ser. No. 11/638,184, the disclosure of which is incorporated herein by reference. As illustrated, the tray 57 includes a bottom surface 59 and a side wall 61 surrounding the bottom. The side wall 61 includes a generally vertical portion and may optionally include horizontal grasping portion or rim 63. End rims 65 extend from each end of the tray 57 and form a grasping portion. The end piece 56 includes a rear surface 58 having at least one top piece 60 and bottom piece 62 extending therefrom. The rear surface 58, top piece 60 and bottom piece 62 define a channel 74 therebetween. The top piece 60 includes at least one protrusion 64 structured to fit within a corresponding depression 66 defined on the end rim 65 of the tray 57 (FIG. 6). The protrusion 64 may extend downward from the top piece 60 or be the thickness of the top piece 60, engaging depression 66 defined within the tray 57 to facilitate frictional attachment of the end piece 56 to the tray 57. The end piece 56 further includes a pair of feet 84 that assist in stacking of one tray on top of another.

The end pieces of the present invention are preferably made from a material that may withstand the temperatures commonly found within various heating equipment in restaurants or the like. Some equipment may result in temperatures upwards of 200° F. Materials from which an end piece 10 may be made include nylon, ABS, polyurethane, polysolfone, polyphenylsolfone, polypropylene, polyethylene, polyetherimide and polyphenylene sulfide.

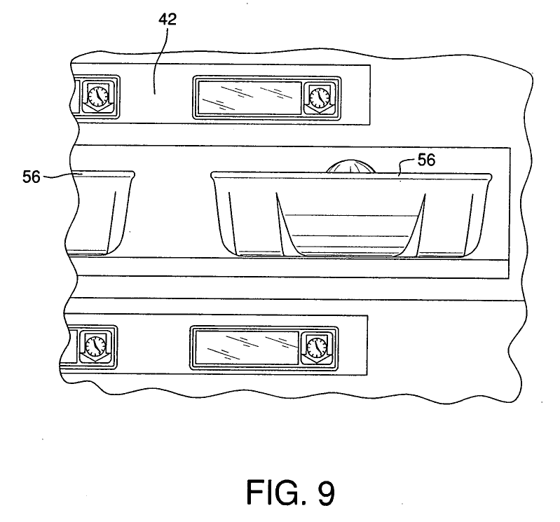

In use, an end piece is clipped onto at least one edge of a tray, or to each of the two opposing edges of a tray. The end piece may remain with the tray throughout food processing so that the color of the end piece identifies the contents of the tray. If multiple trays are placed, for example, in an oven (see FIG. 9), only the edges are typically visible. The contents of the trays can thus be identified by the color of the end piece, rather than requiring temporary removal of the tray from the oven. The end pieces may be left on the trays when stored, with the bottom surface of one end piece resting on the top surface of the end piece below it, thereby providing stability to the stack (see, e.g., FIG. 4). Alternatively, the bottom surface of a tray may rest on the top surface of an end piece, providing the advantages of stabilizing the stack of trays and insulating adjacent trays from each other. During cleaning of the trays, the end pieces may be left in place on the trays or removed from the trays, depending upon the preferences of the user.

Referring to FIG. 9, a tray having an end piece 56 (for example) secured thereto is illustrated within a warming oven 42. Although the contents of the tray are not visible, the end piece 56 secured to the tray is clearly visible. If the color of the end piece 56 has been selected to correspond to specific food items, then the contents of each tray are identified by the color. Additionally, the end piece 56 may provide insulation for the edge of the tray, thereby creating a more uniform heat distribution throughout the tray and causing food thereon to be heated more evenly.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. An end piece for a tray, the tray having a bottom and a side wall surrounding the bottom, the side wall having an edge, the end piece comprising:
a first wall;
a second wall; and
a third wall,
the second and third walls extending from the first wall to define a channel therebetween, the channel structured to removably secure the edge of the tray therein,
whereby the end piece is visible when the edge of the tray to which the end piece is secured is viewed.

2. The end piece according to claim 1, further comprising at least one protrusion structured to engage a depression defined on the tray.

3. The end piece according to claim 1, wherein at least one of the first wall and second wall includes a hook extending towards the other of the walls, the hook structured to engage an edge of the tray.

4. The end piece according to claim 1, further comprising an opening defined within the third wall, the opening being structured to receive a handle extending from the edge of the tray.

5. The end piece according to claim 4, wherein the opening includes a channel defined between a pair of opposing end portions of the second wall.

6. The end piece according to claim 1, wherein the end piece is made from a material that is capable of withstanding temperatures as high as about 200° F.

7. The end piece according to claim 6, wherein the end piece is made from a material selected from the group consisting of nylon, ABS, polyurethane, polysolfone, polyphenylsolfone, polypropylene, and polyethylene.

8. The end piece according to claim 1, wherein the second wall includes a lower edge structured to abut an upper edge of another second wall of another end piece, whereby a plurality of trays having end pieces secured to opposing edges may be stacked with the end pieces supporting each tray within the stack.

9. An end piece for a tray, the tray having a bottom and a side wall surrounding the bottom, the side wall having an edge with a handle extending from the edge, the end piece comprising:
a face defining a pair of ends; and
a wing extending from each end, each wing having a generally J-shaped profile when viewed from a top, the wings being structured to wrap at least partially around the handle to removably secure the end piece to the tray edge.

10. The end piece according to claim 9, wherein at least one of the face and the pair of wings includes a hook extending towards the other of the face or the pair of wings, the hook being structured to engage a lip defined on the edge of the tray.

11. The end piece according to claim 9, wherein the end piece is made from a material that is capable of withstanding temperatures as high as about 200° F.

12. The end piece according to claim 11, wherein the end piece is made from a material selected from the group consisting of nylon, ABS, polyurethane, polysolfone, polyphenylsolfone, polypropylene, and polyethylene.

13. The end piece according to claim 9, wherein the wings include a lower edge structured to abut an upper edge of another pair of wings of another end piece, whereby a plurality of trays having end pieces secured to opposing edges may be stacked with the end pieces supporting each tray within the stack.

14. A method of identifying trays used for different contents, the method comprising:
providing an end piece having a color selected to correspond to a content of a tray;
removably securing the end piece to an edge of the tray; and
placing the tray in a storage location or a processing location with the edge having the end piece visible.

15. The method according to claim 14, wherein the processing location is a cooking location.

16. The method according to claim 15, wherein the end piece is made from a material selected from the group consisting of nylon, ABS, polyurethane, polysolfone, polyphenylsolfone, polypropylene, and polyethylene.
